(19) United States
(12) Patent Application Publication
(10) Pub. No.: US 2004/0055956 A1
(43) Pub. Date: Mar. 25, 2004

(54) Microfluidic device including purification column with excess diluent, and method

(76) Inventor: Michael P. Harrold, San Mateo, CA (US)

Correspondence Address: KILYK & BOWERSOX, P.L.L.C., 3603 CHAIN BRIDGE ROAD, SUITE E, FAIRFAX, VA, 22030, US

(21) Appl. No.: 10/628,281

(22) Filed: Jul. 28, 2003

Related U.S. Application Data
(63) Continuation-in-part of application No. 10/414,179, filed on Apr. 14, 2003.
(63) Continuation-in-part of application No. 10/426,587, filed on Apr. 30, 2003.
(60) Provisional application No. 60/398,852, filed on Jul. 26, 2002.
(60) Provisional application No. 60/398,778, filed on Jul. 26, 2002.

(51) Int. Cl. B01D 15/00

(52) U.S. Cl. 210/660

(57) ABSTRACT

Methods, apparatus, and a system are provided for processing a sample in a fluidic device. The device can include a purification column, an entrance opening to the purification column, an output reservoir, a fluid communication between the purification column and the output reservoir, and an openable and recloseable valve capable of interrupting fluid flow through the fluid communication. Methods of processing samples using such a device are also provided.

### CROSS-REFERENCE TO RELATED APPLICATIONS

The present application claims the benefit from earlier filed U.S. Provisional Patent Applications Nos. 60/398,852 and 60/398,778, both filed Jul. 26, 2002, and is a continuation-in-part of U.S. patent application Ser. No. 10/414,179, filed Apr. 14, 2003, and a continuation-in-part of U.S. patent application Ser. No. 10/426,587, filed Apr. 30, 2003. Cross-reference is also hereby made to U.S. patent applications Ser. Nos. 10/336,706; 10/336,274; and 10/336,330, all filed Jan. 3, 2003. All of the provisional patent applications and patent applications referenced herein are incorporated herein in their entireties by reference.

### FIELD

The present teachings relate to a method, device, and system for the purification of a sample.

### BACKGROUND

In the case of microfluidic sample preparation, the loaded sample volume can be of a sub-microliter size. Such small volumes can be incompatible with capillary analysis devices and systems, such as capillary sequencer injection devices and systems. In order to use the sub-microliter sample volume with a capillary sequencer, the sample volume can be increased with a make-up volume of buffer, or diluent.

### SUMMARY

According to various embodiments, a microfluidic device is provided that includes a purification column, an output chamber, a first fluid communication between the purification column and the output chamber, and an openable and recloseable first valve for interrupting fluid flow through the first fluid communication. A purification material including an excess of diluent can be disposed in the purification column, for example, initially. The device can include valving to enable the excess diluent to move from the purification column into the output chamber to provide a removed diluent. The purification column can then be used to purify a fluid sample and provide a purified species in the output chamber. According to various embodiments, the purification column can receive a product of a reaction, for example, a nucleic acid sequence amplification reaction product.

According to various embodiments, a system for purifying a fluid sample can include a microfluidic device as described above, a platen including an axis of rotation, a holder for securing the microfluidic device to the platen and a drive unit. The system can also include a drive control unit. According to various embodiments, the system can include a heat source capable of heating the device, and a heat control unit capable of controlling the heat source. The heat source can substantially direct heat to a reaction chamber of the device.

According to various embodiments, a method of purifying a fluid sample using a fluidic device or system is provided. The method can include providing a fluidic device that includes a purification column that retains therein a purification material saturated with diluent and excess diluent, moving the excess diluent from the purification column into an output reservoir to provide a removed diluent, introducing a fluid sample into the purification column through an entry port in the fluidic device, moving the fluid sample through the purification column and into the output reservoir to provide a purified species, and mixing the purified species with the removed diluent in the output reservoir. The fluidic device can be a microfluidic device, that is, a fluidic device having a fluid pathway that includes a minimum dimension of 500 microns or less.

According to various embodiments, moving the excess diluent can include generating a moving force. According to various embodiments, moving the fluid sample can include generating a moving force. The moving force for moving the excess diluent and/or for moving the fluid sample can be, for example, a centripetal force, a hydraulic force, a pneumatic force, or a combination of such forces.

According to various embodiments, the method can include loading the purification column with the purification material saturated with diluent and the excess diluent. The loading can include filling the purification column with the purification material saturated with diluent, and adding excess diluent to the purification column. According to various embodiments, the purification material can contain the excess diluent. The purification material and excess diluent can be added to the purification column through an entry port or entrance opening of the purification column. According to various embodiments, moving the excess diluent can be performed after introducing the fluid sample in the fluidic device, for example, after introducing the fluid sample into the purification column through the entry port. The purified species and the removed diluent resulting from processing can be used in a capillary electrophoresis detection system, for example. According to various embodiments, the removed diluent can be used as a make-up volume.

According to various embodiments, the fluid sample can include a nucleic acid sequence. According to various embodiments, the purified fluid sample can be the product of a size-exclusion chromatography (SEC), a size-exclusion ion-exchange (SEIE) treatment, a sequencing reaction, a nucleic acid amplification reaction, or the product of a combination of such processes.

The device, system, and method provided herein can be more fully understood with reference to the accompanying figures and the description thereof. Modifications that would be recognized by those skilled in the art are considered a part of the present invention and are within the scope of the appended claims. Additional embodiments are set forth in part in the description that follows, and in part will be apparent from the description, or may be learned by practice of the various embodiments described herein.

### BRIEF DESCRIPTION OF THE DRAWINGS

Various embodiments of the present teachings are exemplified in the accompanying drawings. The teachings are not limited to the embodiments depicted, and include equivalent structures and methods as set forth in the following description and known to those of ordinary skill in the art. In the drawings:

FIG. 1a-d are a perspective top view of a sample processing device including a pathway, illustrating a sample flowing along the pathway;

FIG. 2 depicts an embodiment of a microfluidic device processing system comprising microfluidic devices, secured to a rotative platen, by a holder;

FIG. 3a depicts a first step of an exemplary sample purification method that includes providing a purification column with a purification material saturated with diluent and excess diluent;

FIG. 3b depicts a second step of an exemplary sample purification method that includes moving excess diluent from the purification column shown in FIG. 3a to an output reservoir by applying a force;

FIG. 3c depicts a third step of an exemplary sample purification method that includes introducing a sample into the purification column shown in FIG. 3b;

FIG. 3d depicts a fourth step of an exemplary sample purification method that includes moving a purified sample from the purification column shown in FIG. 3c into the output reservoir shown in FIG. 3c; and

FIG. 4 is a perspective top view of a microfluidic sample processing device having a microfluidic pathway for processing a sample.

It is understood that the foregoing general description and the following detailed description are exemplary and explanatory only and are intended to provide further explanation of the various embodiments of the present teachings.

### DESCRIPTION OF VARIOUS EMBODIMENTS

According to various embodiments, a microfluidic device is provided that includes an entry port or entrance opening, a purification column, an output reservoir, a fluid communication between the purification column and the output reservoir, and an openable and closeable valve capable of interrupting fluid flow through the fluid communication. The purification column, entrance opening, output reservoir, and fluid communication can all be formed in or on a single substrate. According to various embodiments, the microfluidic device can be formed of two or more substrate layers such that at least one of the features of the purification column, entrance opening, output reservoir, or fluid communication, can be formed in a different substrate layer than one or more of other features. According to various embodiments, more than one sample processing pathway can be formed on or in a substrate, for example, the device can be a multi-channel device. The substrate can include, for example, a silicon material, a glass material, a polymeric material, for example, polydimethylsiloxane, polycarbonate, an acrylonitrile-butadiene-styrene copolymer (ABS), a polycarbonate/ABS blend, polyvinyl chloride, polystyrene, polypropylene oxide, an acrylic-containing material, polybutylene terephthalate, a blend of polyethylene terephthalate, a nylon, a blend of nylon, or a combination of such materials. The substrate can include a polyalkyline material, a fluoropolymer material, a cyclic-olefin polymer material, or a combination thereof or with other materials. The substrate can be any suitable shape, for example, square, rectangular, polygonal, circular, oval, or any other geometric shape.

According to various embodiments, a plurality of microfluidic pathways can be arranged in a linear array on a single substrate. Suitable arrangements are described, for example, in U.S. patent applications Ser. Nos. 10/336,330, 10/336,706, and 10/336,274, all filed Jan. 3, 2003, and all incorporated herein in their entireties by reference. Other suitable arrangements known to those of ordinary skill in the art can be used. Such an arrangement can allow for automatic delivery of excess diluent, purification material, and/or a sample to a purification column of each pathway. Such materials can be automatically delivered by automated systems as known to those of ordinary skill in the art, for example, by a robotic pipetting tool. According to various embodiments, a microfluidic device or one or more pathways of a microfluidic device can be pre-loaded at or near the time of device manufacture with appropriate reactants, reagents, buffers, or other diluents or other materials useful for carrying out desired reactions in the device known to those of ordinary skill in the art.

The substrate can be rectangular. The substrate can have a length of, for example, from about 1 inch to about 10 inches, wherein the length is defined as a direction parallel to one or more pathways in the substrate. Depending upon the number of pathways in a substrate, the substrate can have any appropriate size. Disk-shaped substrates can have diameters, for example, of from about 1 inch to about 12 inches, or from about 4 inches to about 5 inches. The substrate can have any suitable thickness. The substrate thickness can be from about 0.5 mm to about 1 centimeter, for example, according to various embodiments. A rectangular shaped substrate having a length of from about 2 inches to about 5 inches, a width of from about 1 inch to about 3 inches, and a thickness of from about 1 mm to about 1 cm is exemplary. The substrate can include a single layer of material, a coated layer of material, a multi-layered material, or a combination thereof An exemplary substrate is a single-layered substrate of a hard plastic material, for example, polycarbonate on a cyclic-olefin copolymer.

According to various embodiments, the microfluidic device can include a substrate that has a cover on one or both of a top side and a bottom side of the substrate. The cover can be a frangible material or a resilient material. The cover can be a tape, a film, a sheet, a membrane, a substrate, or a combination thereof According to various embodiments, the cover can be gas-permeable. The cover can be hydrophobic. The cover can be hydrophilic. According to various embodiments, the cover can have a thickness of from about 0.01 mm to about 3 mm, although other suitable thicknesses can be used as appropriate based on the cover material, substrate, microfluidic device, and sample fluid composition. According to various embodiments, the cover can function as one side of a chamber, channel, sample well, reservoir, purification column, or other structure in a substrate having a microfluidic device. The cover can be used to retain a fluid sample or diluent when a moving force is applied to the microfluidic device.

Substrate materials can be used to form the cover. Suitable cover materials can include, for example, polyolefinic films, polymeric films, co-polymeric films, or a combination thereof A PCR tape material can be used as the cover. The cover can be a semi-rigid plate that can bend over its entire width or length. The cover can bend or deform locally. The cover can be, for example, from about 10 micrometers to about five millimeters thick, or from about 50 micrometers to about 100 micrometers thick. If an adhesive or adhesive layer is used to bind the cover to the substrate, the adhesive can have a thickness of from about 10 micrometers to about 1 millimeter, or from about 50 micrometers to about 100 micrometers.

According to various embodiments, a substrate can have a series of channels, chambers, and/or wells suitable for manipulation of a sample fluid along a prescribed pathway in the substrate. Fluid samples can be moved along the pathway by a moving force, for example, a centripetal force, hydraulic force, pneumatic force, vacuum, gravity, or by employing other moving forces as known to one of ordinary skill in the art. Centripetal force can be generated, for example, by rotating the device about an axis of rotation while the device is mounted on a spinning platen. A fluid sample can be moved along a pathway in the device by a moving force. Various reactions can be performed on the fluid sample sequentially or simultaneously as the fluid sample moves along the pathway. A microfluidic device as described herein can be all or a portion of a pathway.

According to various embodiments, a microfluidic device can be a laminated, multi-layer device wherein each layer can be the same or a different polymeric material than the remaining layers. According to various embodiments, the device can conform to a Society for Biomolecular Screening (SBS) microplate format. The microfluidic device can be, for example, from about 0.5 mm to about 3.0 mm thick. Other suitable thicknesses can be used depending upon the material of the substrate, the purification column length, and other factors known to those of ordinary skill in the art.

According to various embodiments, a microfluidic device can include a purification column that can enable the purification of small volumes, for example, volumes of from about 0.1 microliter (μl) to about 1 milliliter (ml), or from about 0.5 μl to about 10 μl. According to various embodiments, the microfluidic device can be capable of performing purification of small sample volumes in a high-throughput format, a parallel format, a serial format, a planar format, or a combination thereof.

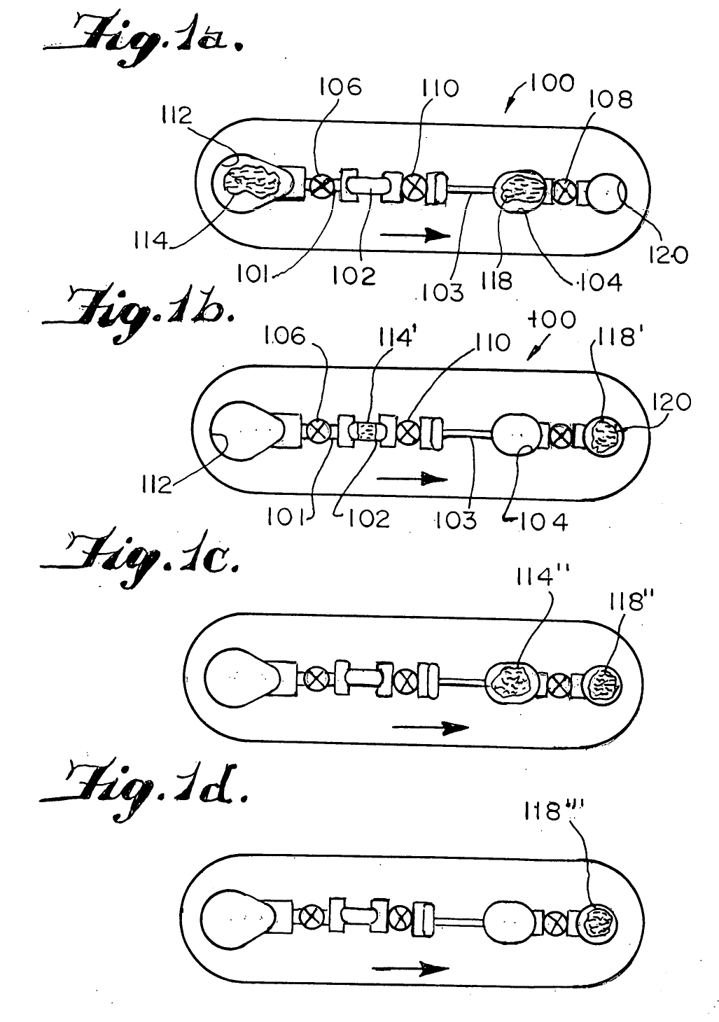

According to various embodiments, and as shown in FIG. 1a, a microfluidic device 100 is provided. FIG. 1a is a top view of the device 100 and a microfluidic pathway formed in the device 100. The pathway includes a sample introduction chamber 112, a first valve 106, a first fluid communication 101, a reaction chamber 102, a second valve 110, a second fluid communication 103, a purification chamber 104, a third valve 108, and an output chamber 120. A sample 114 can be placed in the sample introduction chamber 112. A purification material with an excess diluent 118 can be disposed in the purification chamber 104. The diluent can be a buffer solution, for example, a buffer solution, some water, some deionized water, an organic solvent, or a combination thereof, for hydrating purification material in the purification chamber 104. The pathway in FIG. 1a depicts the first valve 106 in an open state, the second valve 110 in a closed state, and the third valve 108 in an open state. The third valve 108 is shown open in FIG. 1a, but can be provided closed in an initial closed state. The third valve 108 can be in the initial closed state, for example, to retain the excess diluent 118 in the purification chamber 104. The sample 114 loaded in the sample introduction chamber 112, and the device 100, can be subjected to a centripetal force to cause the sample 114 to flow from the sample introduction chamber 112 to the reaction chamber 102. Because valve 108 is shown in an open state the excess diluent 118 from the purification chamber 104 can flow into the output chamber 120 at the same time that the sample 114 flows from the sample introduction chamber 112 to the reaction chamber 102. The removal of excess diluent 118 from the purification chamber 104 need not be performed at this time, for example, if the third valve 108 is closed. The removal of excess diluent 118 can occur anytime before a sample to be purified is loaded into the purification chamber 104. The second valve 110 can be closed during the loading of the sample 114 and the sample 114 can thus be collected in the reaction chamber 102. The excess diluent 118 from the purification chamber 104 can be collected in the output well 120. The reaction chamber 102 can be an amplification chamber and can have amplification reagents and reactants preloaded therein. The purification chamber 104 can have a purification material with excess diluent loaded therein prior to use. The preloading can be done at the time of manufacturing the device, for example.

After the pathway has been loaded as described with respect to FIG. 1a, the pathway 100 can be spun, leaving the pathway as depicted in FIG. 1b. The first valve 106 can then be closed while the second valve 110 remains closed. The third valve 108 can be changed to a closed state if so desired, but does not necessarily have to be closed. After the first valve 106 has been closed, the reaction chamber 102 can be sealed, for example, to prevent evaporative loss of reaction product 114′ in the reaction chamber 102 if treated at an elevated temperature. The reaction product 114′ of the reaction chamber 102 can be subjected to thermal cycling, for example, during a nucleic acid amplification, during a sequencing reaction. The thermal cycling can be carried out in the reaction chamber 102 for a desired number of thermal cycles.

As depicted in FIG. 1b, the excess diluent 118 remains removed from the purification chamber 104 and collected in the output chamber 120, in the form of a removed excess diluent 118′. The purification chamber 104 is ready to receive and collect a product from the reaction chamber 102 upon completion of a reaction in the reaction chamber 102.

Subsequent to a reaction, the second valve 110 can be opened and the device 100 can be spun. The resultant centripetal force can transport the reaction product 114′, from the reaction chamber 102 through the second valve 110, through second fluid communication 103, and into the purification column 104. The third valve 108 remains closed. The state of the first valve 102 does not necessarily have to change. FIG. 1c depicts the state of the pathway and device 100 after the reaction product 114′ has been moved into the purification chamber 104.

FIG. 1d depicts the state of the pathway and device 100 after the purification process has been carried out in the purification chamber 104. The state of the third valve 108 has been changed to an open state and the device 100 has been spun. The resultant centripetal force from spinning can transport the reaction product 114′, after purification, from purification chamber 104 into the output chamber 120 where it can be diluted with the previously removed excess diluent 118′. The result is a diluted, purified, reaction product 118″.

The pathway 100 can include features that allow for retention of the purification material in the purification chamber 104. The pathway 100 can include features that allow the reaction chamber 102 to retain the amplification reagents, if necessary. The first valve 106, the second valve 110, the third valve 108, the first fluid communication 101, the second fluid communication 103, or a combination thereof, can be configured to substantially allow only particulates smaller than a predetermined size, and fluids, to flow therethrough. Microfluidic flow restrictor devices, for example, as described in U.S. patent application Ser. No. 10/336,706, frits, and membranes, are exemplary devices capable of substantially prohibiting particulate flow and retaining the purification material in the purification column.

According to various embodiments, a microfluidic device can include a purification column, an output chamber, a first fluid communication between the purification column and the output chamber, and an openable and recloseable first valve for interrupting fluid flow through the first fluid communication. A purification material with an excess of diluent can be disposed in the purification column. The excess diluent can be moved from the purification column into the output chamber to provide a removed diluent. The purification column can be capable of purifying a fluid sample to provide a purified sample. The purification column can be capable of receiving a product of a reaction site. According to various embodiments, the output chamber can be capable of providing a sample to a reaction site. The first valve can be in a closed state. The first valve can be in an open state. According to various embodiments, the microfluidic device can include a reaction chamber, a second communication between the purification column and the reaction chamber, and an openable and recloseable second valve for interrupting fluid flow through the second fluid communication. The purification material can have an average particulate size. The first fluid communication can be capable of substantially prohibiting the flow of a material having the average particulate size. The first valve can be capable of substantially prohibiting the flow of material having average particulate size.

According to various embodiments, one or more of the valves can be opened and reclosed. According to various embodiments, one or more valves can be reopenable. According to various embodiments, one or more of the valves can be as described, for example, in U.S. patent application Ser. No. 10/336,274, filed Jan. 3, 2003, which is incorporated herein in its entirety by reference.

According to various embodiments, the sample introduction chamber can include an entry port that can be a hole, an aperture, an opening, or any other feature that provides an entrance to the purification column and is in fluid communication therewith. According to various embodiments, the entry port can be a chamber, channel, or other structure for containing, retaining, or directing a fluid sample, and that is in fluid communication with the purification column. According to various embodiments, the entry port can include an output opening in fluid communication with a reaction chamber. For example, the device can include more than one pathway such that the entry port of a second microfluidic device can be the output chamber from the first microfluidic device.

According to various embodiments, the output reservoir can be a hole, an aperture, an opening, or any other feature that provides an exit from a purification column and is in fluid communication therewith. The output reservoir can be a chamber, channel, sample well, or other structure suitable for containing, retaining, or directing a fluid sample, and that is in fluid communication with the purification column. The output reservoir can be an input chamber for a further reaction chamber or device. For example, the device can include more than one microfluidic pathway connected such that the output reservoir of a first microfluidic pathway is the input chamber of a second microfluidic pathway. The output reservoir can be an input chamber of a PCR reaction chamber, an isothermal nucleic acid sequence amplification reaction chamber, a size-exclusion chromatography chamber, an ion-exchange reaction chamber, a nucleic acid ligation chamber, an enzymatic reaction chamber, a size-exclusion ion-exchange reaction chamber, or another physical or chemical reaction chamber.

According to various embodiments, the entry port and the output reservoir of the purification column can each individually be located in a first surface of the substrate, in an opposite second surface of the substrate, in a side of the substrate, in a core of the substrate, or in some combination thereof The entrance opening, entry port, output reservoir, or a combination thereof, can be formed by deforming the substrate, for example, to form a communication with the purification column. The entry port and/or the output reservoir can be designed to enable venting of gas from the purification column.

According to various embodiments, the purification column can be a column, a chamber, a channel, a well, a test tube, a capillary, or any other structure suitable for containing, retaining, or encapsulating a purification material, diluent, and a fluid sample. The purification column can contain a purification material. The purification material can be any material that is capable of retaining an undesired species from a fluid sample on the purification column while not retaining desired species. For example, the purification material can be a size-exclusion chromatography matrix, an affinity matrix, a gel-exclusion matrix, an ion-exchange resin matrix, size-exclusion ion-exchange particles, or other materials capable of separation and purification of a fluid sample, or combination thereof According to various embodiments, the purification material can be a powder, a particulate material, beads, a frit, or a combination thereof The purification material can be disposed in or loaded into the purification column in a dried form, sprayed into the purification column to adhere to the structure of the purification column, added to the purification column with a diluent, or loaded in any combination thereof

According to various embodiments, the purification column can be a chamber that is rectangular in shape. An exemplary purification column can be about 0.50 mm deep, about 0.50 mm wide, and about 20 mm long, providing a 5 microliter total volume. The purification column can accommodate volumes from about 1 nanoliter to about 75 microliters, from about 5 microliters to about 15 microliters, or about 10 microliters. According to various embodiments, the purification column can have the same height as the thickness of the substrate in which the purification column is formed.

According to various embodiments, a purification material can be added to a purification column at manufacture, or before use of the purification column. The purification material can be saturated with a diluent. The purification material can be over-saturated with diluent so as to provide an excess diluent in the purification column. According to various embodiments, the purification material can be introduced into the purification column through the entrance opening.

According to various embodiments, a sample processing system having a microfluidic device as provided herein can be used for sample purification. FIG. 2 depicts an exemplary sample processing system 399 that can include a platen 380 that revolves around an axis of rotation 386. The platen 380 can have holders 381 and 383 for holding and securing microfluidic devices, or other devices, that include one or more microfluidic pathways. The platen 380 can have a heating element 388, an optional control unit 390 for controlling heating element 388, a drive unit (not shown), and an optional drive control unit (not shown) for controlling the drive unit. These and other features can be disposed on or set into a surface of the platen. FIG. 2 indicates a direction of rotation of the platen with an arrow. According to various embodiments, the direction of the rotation can be in the opposite direction of that shown in FIG. 2.

In the exemplary sample processing system of FIG. 2, a fluid sample can be moved through the processing system by centripetal force. A fluid sample can be moved through the pathway by a moving force, such as centripetal force, hydraulic force, pneumatic force, vacuum, gravity, or other moving force known to those skilled in the art.

According to various embodiments, a sample processing system can include microfluidic device holders on a platen to orient a pathway of one or more microfluidic device off-axis with regard to an axis of rotation of the platen. According to various embodiments, the device holder can align the pathways of multiple microfluidic devices such that when a pathway of each device is parallel to a radius of the platen, all of the pathways lie off of the radius and optionally on the same side of the radius of the platen.

According to various embodiments, a sample processing system can include one or more microfluidic device and a plurality of pathways in each device. The sample processing system can be disposed in a device holder of a platen, and each input chamber of the plurality of pathways can be closer to an axis of rotation of the platen than to each respective output chamber of the plurality of pathways. The plurality of pathways can include parallel pathways. According to various embodiments, each of the plurality of pathways of the device can include a respective entrance opening, at least one purification column, and an output reservoir, for example, in a linear arrangement.

According to various embodiments, a sample processing system can include one or more microfluidic device disposed in a holder on a platen such that a radius or center line of the platen can be normal to a length or a width of the microfluidic device. The microfluidic device can include pathways that extend parallel to a length or a width of the microfluidic device. The platen can be a circular, oval, rectilinear, rectangular, square, polygonal, or any other suitable geometric shape.

According to various embodiments, a method of purifying a microfluidic sample, wherein an undesirable species of the sample can be retained on a purification column and a purified species can be passed from the column to an output reservoir, is provided. The sample can be the product of one or more of size-exclusion chromatography, ion-exchange, size-exclusion ion-exchange, and other separation or purification processes known to those of ordinary skill in the art. The method can include one or more of size-exclusion chromatography, ion-exchange, size-exclusion ion-exchange, and other purification processes known to those of ordinary skill in the art. Purified species generated by the method can be used for further processing, such as, for example, capillary electrophoresis analysis, DNA sequencing, further purification or separation processes, or further reactions, such as, for example, nucleic acid sequence amplification.

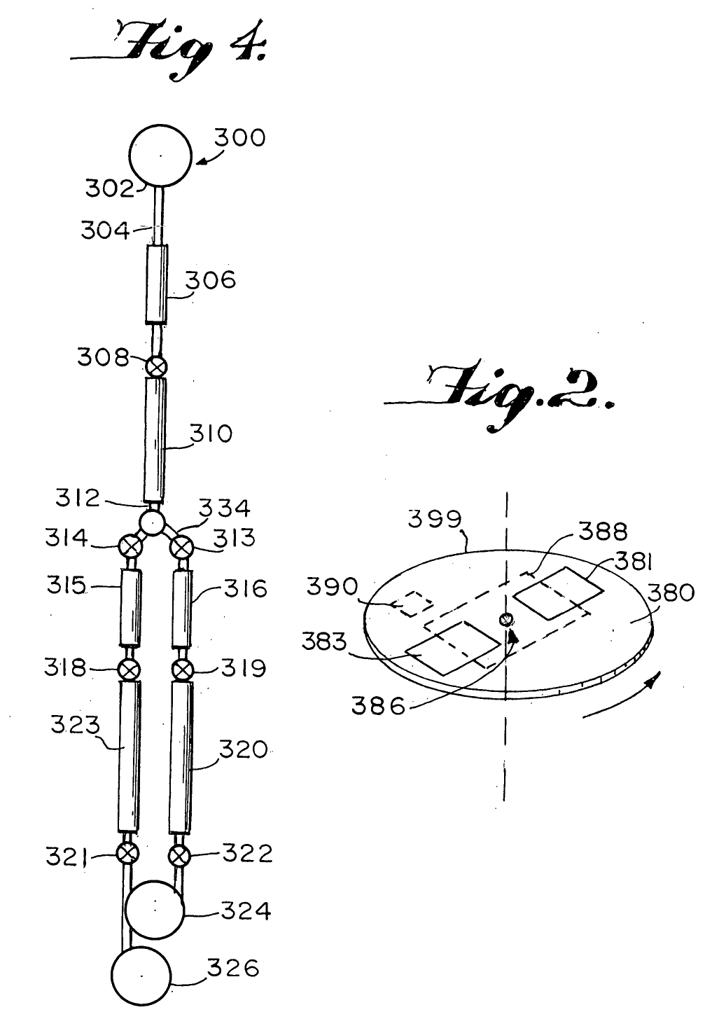

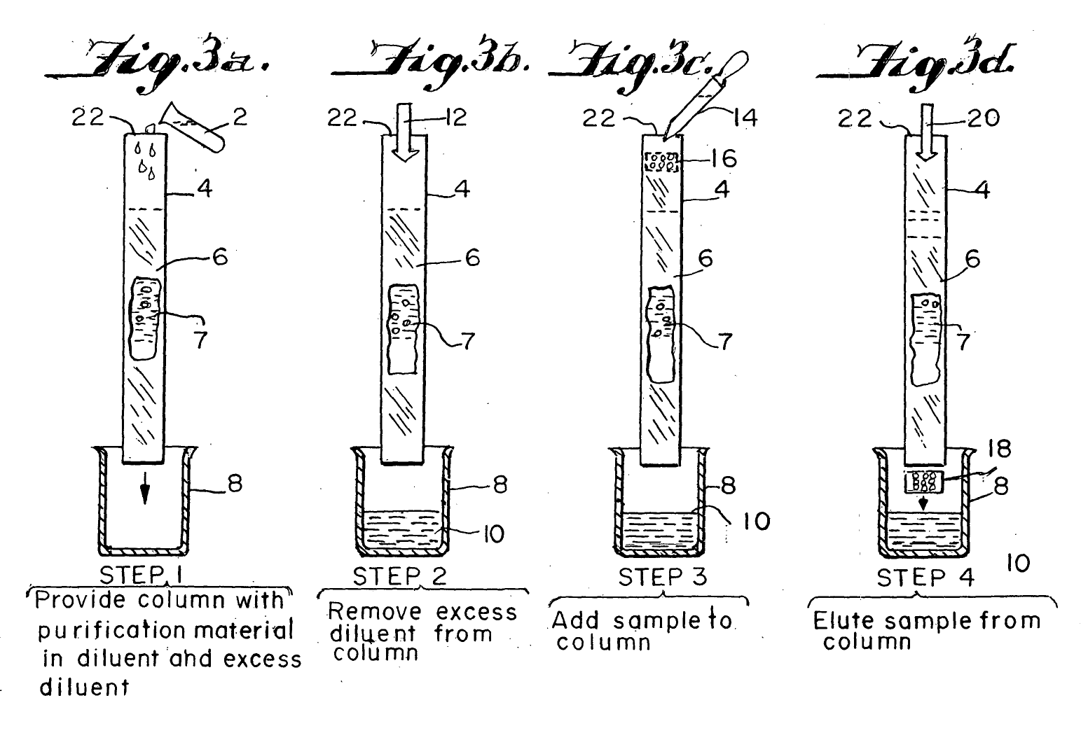

According to various embodiments, a method of purification can include providing a microfluidic device as described herein, providing the purification column of the microfluidic device with a purification material saturated with diluent and excess diluent, moving the excess diluent from the purification column to an output reservoir to provide a removed diluent, introducing a fluid sample through an entrance opening to the purification column, and moving the fluid sample through the purification column to provide a purified species in the output reservoir. An exemplary method is depicted in FIGS. 3a-3d, described below.

As shown in FIG. 3a, a purification column 4 can be filled with a purification material 7, for example, a slurry resin, saturated with a diluent 6. Excess diluent 2 is added to the purification material 7 through an entrance opening 22. The purification column 4 can be prefabricated with purification material 7 saturated with diluent 6 and, optionally, with excess diluent 2. Purification column 4 can be filled with purification material 7 at the time of substrate manufacture or at the time of use through entrance opening 22. An output reservoir 8 capable of receiving removed diluent from purification column 4 can be disposed in fluid communication with purification column 4.

As shown in FIG. 3b, a moving force acting in the direction of arrow 12 can be applied to purification column 4 to move excess diluent 2 from the purification column 4 into output reservoir 8 as removed diluent 10. Moving the excess diluent 2 can also pack purification material in the purification column 4. A moving force as indicated by arrow 12 can be a hydraulic force, a pneumatic force, or a centripetal force. Other moving forces, for example, gravity or vacuum, can be used. Removed diluent 10 can be an interstitial volume or a make-up volume. According to various embodiments, after application of the moving force, purification material 7 can remain saturated with diluent 6 and can optionally be free of excess diluent.

As shown in FIG. 3c, a fluid sample 16 can be added to purification column 4 through entrance opening 22 by a sample injector 14. Sample injector 14 can be, for example, a dropper, a needle, a nozzle, a pipette, or a combination thereof The fluid sample can be introduced manually, or can be automatically introduced by a robot or other controlled mechanism. Fluid sample 16 can be a mixture including undesired species, and a desired species 17. As shown in FIG. 3c, circles in fluid sample 16 represent a desired species 17. According to various embodiments, the undesired species can include, for example, nucleotides and salts. According to various embodiments, the desired species 17 can include, for example, DNA sequencing ladders, nucleic acid sequences, or amplification products of nucleic acid sequences. According to various embodiments, the fluid sample 16 can be introduced into the purification column 4 through an entrance opening 22 that includes an output of a reaction chamber. According to various embodiments, loading of fluid sample 16 in column 7 can move excess diluent 2 from column 4 to output reservoir 8 as removed diluent 10. According to various embodiments, output reservoir 8 can contain all, a portion, or none of removed diluent 10 at a time when fluid sample 16 is added to column 4.

As shown in FIG. 3d, a moving force in the direction of arrow 20 can be applied to purification column 4 to move fluid sample 16 through purification column 4. A purified species 18 corresponding to desired species 17 can be eluted from purification column 4 by application of the moving force indicated by arrow 20. Moving force 20 can be a hydraulic force, a pneumatic force, or a centripetal force. Other moving forces, for example, gravity or vacuum, can be used. Purified species 18 can be mixed with removed diluent 10 in output reservoir 8. Desired species 17 can elute as purified species 18 mixed with the previously removed diluent 10 in output reservoir 8. Desired species 17 can elute as purified species 18 from purification column 4 into the same diluent that was used to pack purification column 4.

FIG. 4 is an enlarged view of an exemplary pathway 300 that can include an input chamber 302, an input channel 304, a PCR chamber 306, a PCR chamber valve 308, a PCR purification column 310, a PCR purification column valve 312, a flow splitter 334, flow splitter valves 313, 314, a forward sequencing reaction chamber 315, a reverse sequencing reaction chamber 316, sequencing reaction chamber valves 318, 319, a forward sequencing reaction purification column 323, a reverse sequencing reaction purification column 320, a forward sequencing reaction column valve 321, a reverse sequencing reaction column valve 322, a forward sequencing reaction product output chamber 326, and a reverse sequencing reaction product output chamber 324. As shown in FIG. 4, PCR purification column 310, forward sequencing reaction purification column 323, and reverse sequencing reaction purification column 320 each be used as provided herein. Each of the columns 310, 320, 323 can be filled with a purification material saturated with diluent and an excess diluent. A PCR chamber 306, a forward sequencing reaction chamber 315, and a reverse sequencing chamber 316 can function as inputs or entrance openings for columns 310, 320, and 323, respectively. Flow separator 334, forward sequencing reaction product output chamber 326, and reverse sequencing reaction product output chamber 324 can function as output reservoirs for respective columns 310, 320, and 323. Suitable pathways are described in detail, for example, in U.S. patent application Ser. No. 10/336,706 to Desmond et al., filed Jan. 3, 2003, and which is incorporated herein in its entirety by reference.

According to various embodiments, a sample can be a chemical or a biological sample. The sample can be in solution. The sample can be a biological sample, for example, a PCR product or another nucleic acid sequence amplification reaction product. The sample can be an output product of other reaction processes, for example, the product of a size-exclusion chromatography reaction, an ion-exchange reaction, a size-exclusion ion exchange reaction, a forward sequencing reaction, a reverse sequencing reaction, or other reactions or processes, for example, as known to those of ordinary skill in the art. The sample can be in an amount of, for example, from about 1 nanoliter to about 1 milliliter, or from about 1 microliter to about 5 microliters.

The diluent can be any liquid suitable for use with the purification material, the sample, and/or both. The diluent can be selected to not react with or bind to the sample. The diluent can be, for example, a buffer solution, a carrier, a vehicle, a solvent, a reagent, water, or a combination thereof The diluent can be another liquid known to those of ordinary skill in the art. The diluent can be chosen based on the sample composition. The diluent can hydrate a hydrogel purification material. Further diluents and purification materials and columns that can be used include those described, for example, in U.S. patent application Ser. No. 10/414,179, filed Apr. 14, 2003, which is incorporated herein in its entirety by reference.

A description of other materials, components, and methods useful for various features of a microfluidic device, system, and method as described herein is provided, for example, in U.S. patent application Ser. No. 10/336,274 to Bryning et al., which is incorporated herein in its entirety by reference.

Those skilled in the art can appreciate from the foregoing description that the present broad teachings can be implemented in a variety of forms. Therefore, while particular embodiments and examples thereof have been described, the true scope of the teachings should not be so limited. Various changes and modification may be made without departing from the scope of the teachings.

What is claimed is:

1. A method for purifying a fluid sample, the method comprising:
providing a fluidic device having an entry port, a purification column in fluid communication with the entry port, and an output reservoir in fluid communication with the purification column;
providing the purification column with a purification material saturated with diluent, and excess diluent;
moving the excess diluent from the purification column into the output reservoir to provide a removed diluent;
introducing the fluid sample into the purification column through the entry port;
moving the fluid sample through the purification column and into the output reservoir to provide a purified sample in the output reservoir; and
mixing the purified sample with the removed diluent in the output reservoir.

2. The method of claim 1, wherein moving the excess diluent includes generating a moving force.

3. The method of claim 2, wherein the moving force includes a centripetal force.

4. The method of claim 2, wherein the moving force includes a hydraulic force.

5. The method of claim 2, wherein the moving force includes a pneumatic force.

6. The method of claim 1, wherein moving the fluid sample includes generating a moving force.

7. The method of claim 6, wherein the moving force includes a centripetal force.

8. The method of claim 6, wherein the moving force includes a hydraulic force.

9. The method of claim 6, wherein the moving force includes a pneumatic force.

10. The method of claim 1, wherein the fluid sample includes a biological sample.

11. The method of claim 1, wherein the fluid sample includes a nucleic acid sequence.

12. The method of claim 1, wherein the excess diluent is moved through the purification chamber before the fluid sample is introduced into the purification column.

13. The method of claim 1, wherein providing the purification column with the purification material saturated with diluent, and the excess diluent, comprises filling the purification column with the purification material saturated with diluent, and adding excess diluent to the column.

14. The method of claim 1, wherein providing the purification column with the purification material saturated with diluent, and excess diluent, comprises filling the purification column with a mixture of saturated purification material and excess diluent.

15. The method of claim 1, wherein providing the purification column with purification material comprises adding the purification material to the column through the entry port.

16. The method of claim 1, wherein the purification material comprises size-exclusion particles.

17. The method of claim 1, wherein the purification material comprises size-exclusion ion-exchange particles.

18. The method of claim 1, wherein the sample is contacted with the purification material for at least one minute.

19. The method of claim 1, further comprises subjecting the sample to a polymerase chain reaction prior to introducing the fluid sample into the purification column.

20. The method of claim 1, further comprises subjecting the sample to a sequencing reaction prior to introducing the fluid sample into the purification column.

21. The method of claim 1, further comprising subjecting the purified species mixed with the removed diluent, to capillary electrophoresis.

22. The method of claim 1, wherein the fluid sample includes chloride ions and the method includes ion-exchanging the chloride ions in the purification column.

23. The method of claim 1, wherein the fluidic device is a microfluidic device.

24. A microfluidic device comprising:
a purification column, the purification column comprising a chamber and a purification material retained in the chamber, the purification material including an excess of a purification material diluent;
an output chamber;
a first fluid communication between the purification column and the output chamber; and
an openable and recloseable first valve capable of interrupting fluid flow through the first fluid communication.

25. The device of claim 24, wherein the first valve is closed.

26. The device of claim 24, wherein the first valve is open.

27. The device of claim 24, further comprising:
a reaction chamber;
a second communication between the purification column and the reaction chamber; and
an openable and recloseable second valve capable of interrupting fluid flow through the second fluid communication.

28. The device of claim 24, wherein the purification material includes particles having an average particle diameter and the first fluid communication has a minimum dimension that is greater than the average particle diameter.

29. The device of claim 24, wherein the excess diluent comprises a buffer for the purification material.

30. A sample processing system comprising:
the microfluidic device of claim 24;
a platen having an axis of rotation;
a holder capable of holding the microfluidic device on or in the platen; and
a drive unit capable of spinning the platen about the axis of rotation.

31. The sample processing system of claim 30, further comprising a drive control unit capable of controlling the drive unit.

32. The sample processing system of claim 30, further comprising:
a heating unit capable of heating the device; and
a heat control unit capable of controlling the heating unit.
